(19) United States
(12) Patent Application Publication
(10) Pub. No.: US 2018/0049537 A1
(43) Pub. Date: Feb. 22, 2018

(54) Carrying Bag

(71) Applicant: Joy Walton Walton Kawasaki, Olympia, WA (US)

(72) Inventor: Joy Walton Walton Kawasaki, Olympia, WA (US)

(21) Appl. No.: 15/671,552

(22) Filed: Aug. 8, 2017

Related U.S. Application Data
(60) Provisional application No. 62/375,548, filed on Aug. 16, 2016.

(51) Int. Cl. A45F 3/00; A45C 5/14; A45C 13/00; A45C 13/10; A45C 15/06; A45F 3/02; A01K 23/00; F21V 33/00

(52) U.S. Cl. CPC A45F 3/00; A45C 5/14; A45C 13/001; A45C 13/008; A45C 13/10; A45C 15/06; B62B 3/00; A45F 3/02; A01K 23/005; F21V 33/0008; A45F 2003/006; A45F 2003/001; A45F 3/005

(57) ABSTRACT

A carrying bag may have an exterior bag and a rigid interior container to allow a user to safely and discreetly contain and carry objects such as pet waste. The carrying bag may be operable by a user's single hand, giving the user freedom to simultaneously perform tasks such as holding onto a pet's leash with the other hand. An adjustable strap may allow the carrying bag to be carried cross-body, over-the-shoulder, or around the waist.

### FIELD

This disclosure relates generally to a carrying bag.

### BACKGROUND

Many people enjoy taking their pets for a walk but dislike carrying around unsightly used pet waste bags. A conventional carrying bag may require a user to utilize both hands to open and close the carrying bag in order to collect waste, and may not give its contents rigid protection from damage resulting from pressure. This may restrict the user's ability to simultaneously perform tasks, such as holding a pet's leash, with the other hand. A conventional carrying bag may also be susceptible to leakage or breakage.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a carrying bag. A carrying bag may have an exterior bag with a removable rigid interior. A carrying bag may allow a user to safely and discreetly gather and enclose pet waste or other objects until a trash receptacle or another depository becomes available. A carrying bag may be configured to open and close by operation of a user's single hand, allowing the user to simultaneously perform tasks, such as holding a pet's leash, with the other hand. A carrying bag may include an adjustable strap that may allow the user to carry the carrying bag in various positions on the body.

Many of the attendant features may be more readily appreciated as they become better understood by reference to the following detailed description considered in connection with the attached drawings.

### BRIEF DESCRIPTION OF THE DRAWINGS

FIG. 1 illustrates a carrying bag according to one embodiment.

FIG. 2 illustrates a carrying bag according to another embodiment.

FIG. 3 illustrates a carrying bag according to yet another embodiment.

FIG. 4 illustrates a carrying bag according to yet another embodiment.

FIG. 5 illustrates a carrying bag according to yet another embodiment.

FIG. 6 illustrates another view of a carrying bag according to one embodiment.

FIG. 7 illustrates a carrying bag according to yet another embodiment.

Like reference numerals are used to designate like parts in the accompanying drawings.

### DETAILED DESCRIPTION

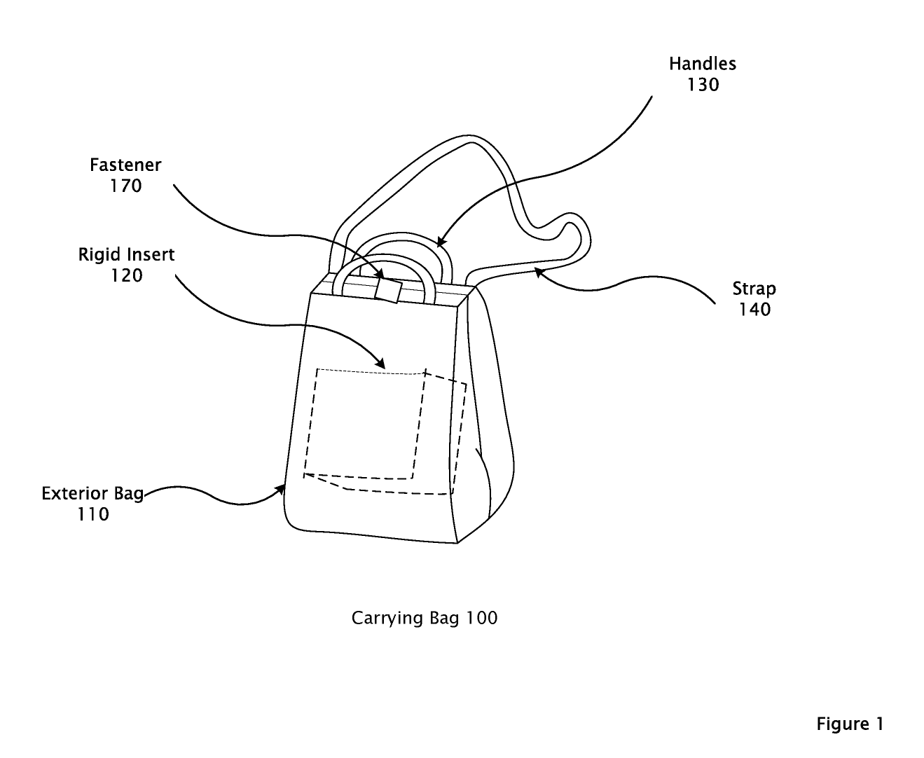

FIG. 1 illustrates Carrying Bag 100 according to one embodiment. Carrying Bag 100 may comprise an Exterior Bag 110, which may be made of various fabrics, such as nylon or neoprene, for example, and may be machine washable. Exterior Bag 110 may be configured to receive a Rigid Insert 120, which may prevent items that are stored inside Carrying Bag from getting damaged. Rigid Insert 120 may protect contents from damage or loss caused by spillage or changes in pressure, moisture, or heat, for example. Rigid Insert 120 may be made of plastic, rubber, or other material, and may be easily removable for cleaning.

Carrying Bag 100 may include Handles 130 for easy carrying and an Adjustable Strap 140, which may be configured to allow a user to carry the Carrying Bag in a cross-body, over-the-shoulder, or around-the-waist manner, for example. Carrying Bag 100 may be light-weight, waterproof, water-resistant, or stain-resistant, and may be made in various colors, shapes, and sizes.

Fastener 170 may hold Exterior Bag 110 closed when fastened. Fastener 170 may use magnets, a friction coupling, hook and loop fasteners, snaps, or any other fasteners to hold securely when closed but open easily, which may allow a user to open Exterior Bag 110 with a single hand.

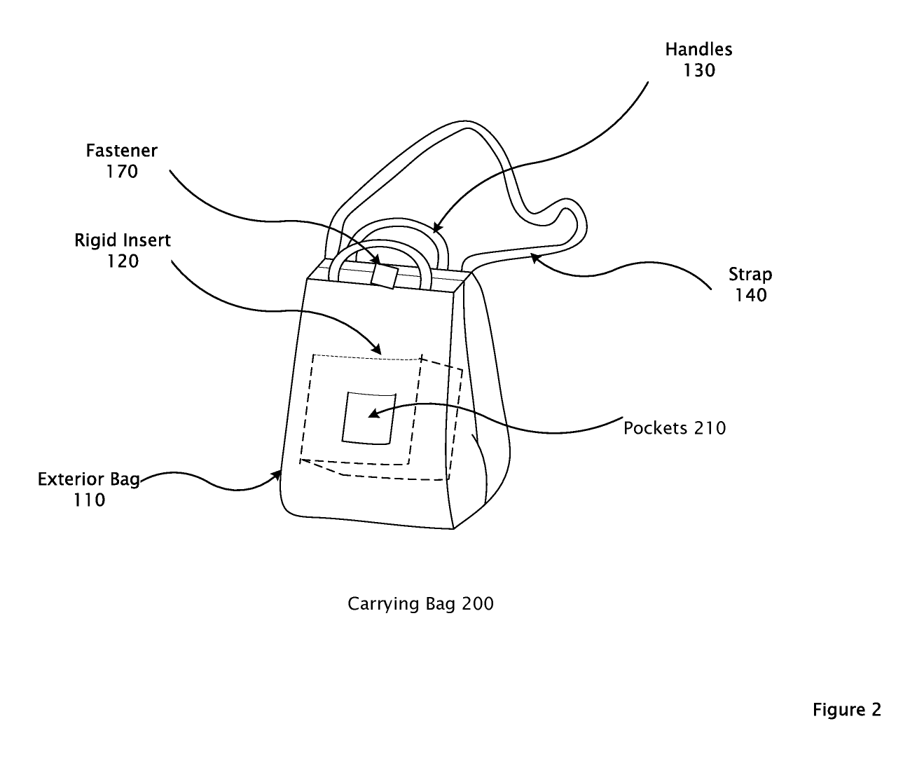

FIG. 2 illustrates Carrying Bag 200 according to another embodiment. Carrying Bag 200 may be configured to be operable by a user's single hand. For example, a user may open and close Carrying Bag 200 using one hand while retaining the ability to use the other hand simultaneously to hold a pet's leash. In Carrying Bag 200 may include interior or exterior Pockets 210 for storing empty plastic or biodegradable waste bags, keys, cards, or other items.

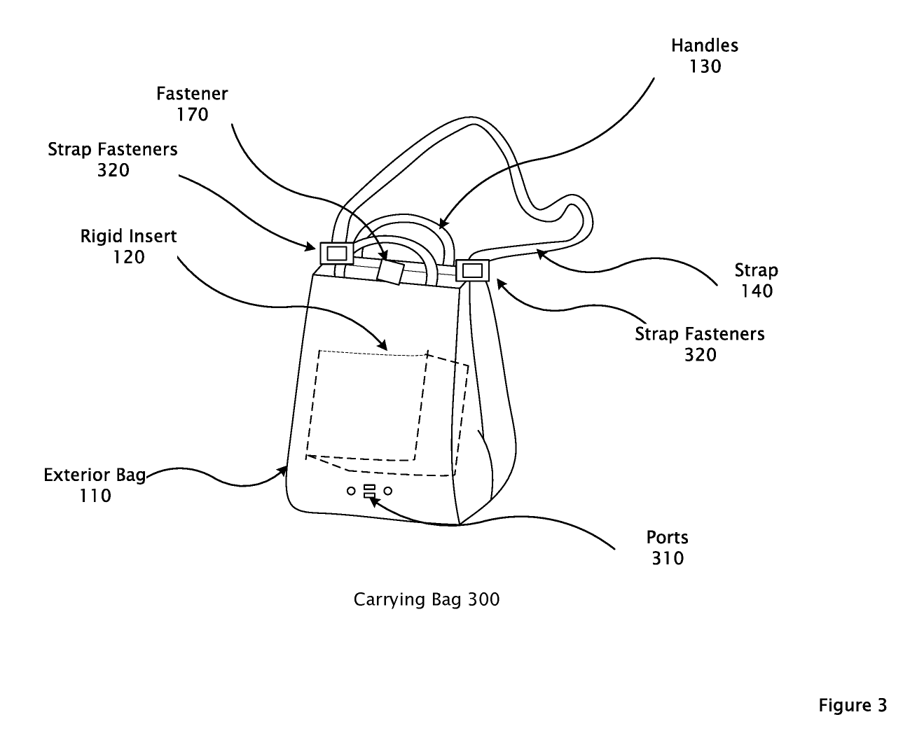

FIG. 3 illustrates Carrying Bag 300 according to yet another embodiment. Carrying Bag 300 may include Ports 310, for example, a headphone jack and USB ports, configured to couple with various mobile devices. For example, Ports 310 may include a battery to provide power to a mobile device. A mobile device may be carried within Carrying Bag 300, and various functions may be accessible through Ports 310. Ports 310 may have a protective cover to be protected from moisture. One having skill in the art will recognize that many different ports may be useful in Carrying Bag 300.

Strap Fasteners 320 may allow Strap 140 to be removed and added as desired. Strap Fasteners 320 may be clasps, slide buckles, hook and loop fasteners, spring clips, or any other type of fastener for securing a strap. In one embodiment, Strap 140 may comprise items from a list containing a wristlet, anklet, belt, and hook. In another embodiment, Carrying Bag 300 may include wheels to prevent the bag from getting dirty or to facilitate travel.

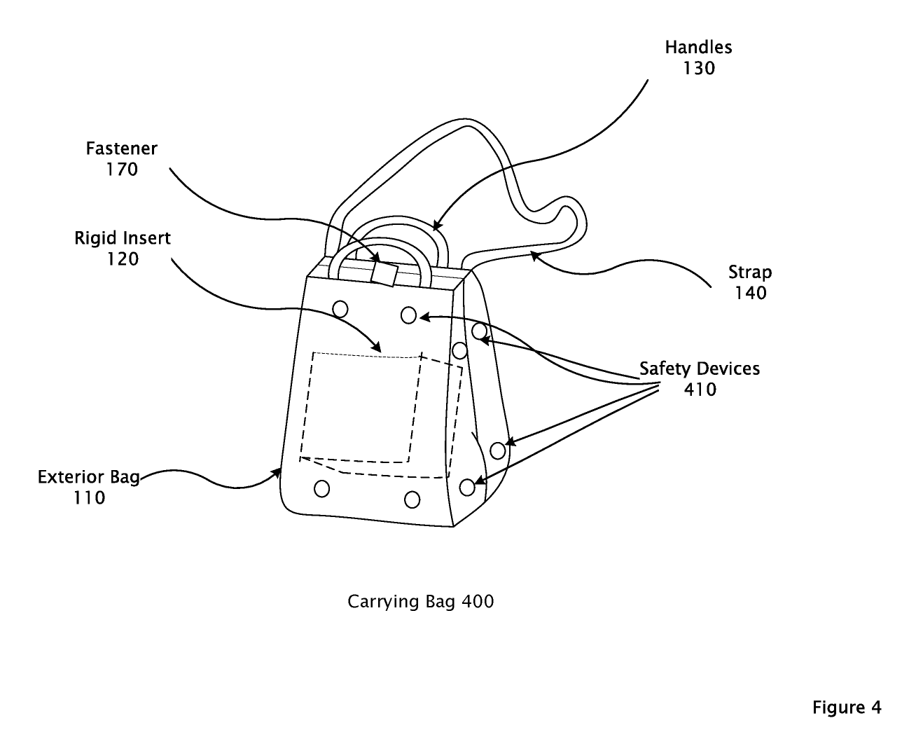

FIG. 4 illustrates Carrying Bag 400 according to yet another embodiment. Carrying Bag 400 may include Safety Devices 410, for enhanced safety in the dark. Safety Devices 410 may be reflective features, light-emitting diodes (LEDs), or other light sources, for example. Carrying Bag 400 may provide a power source for lighting.

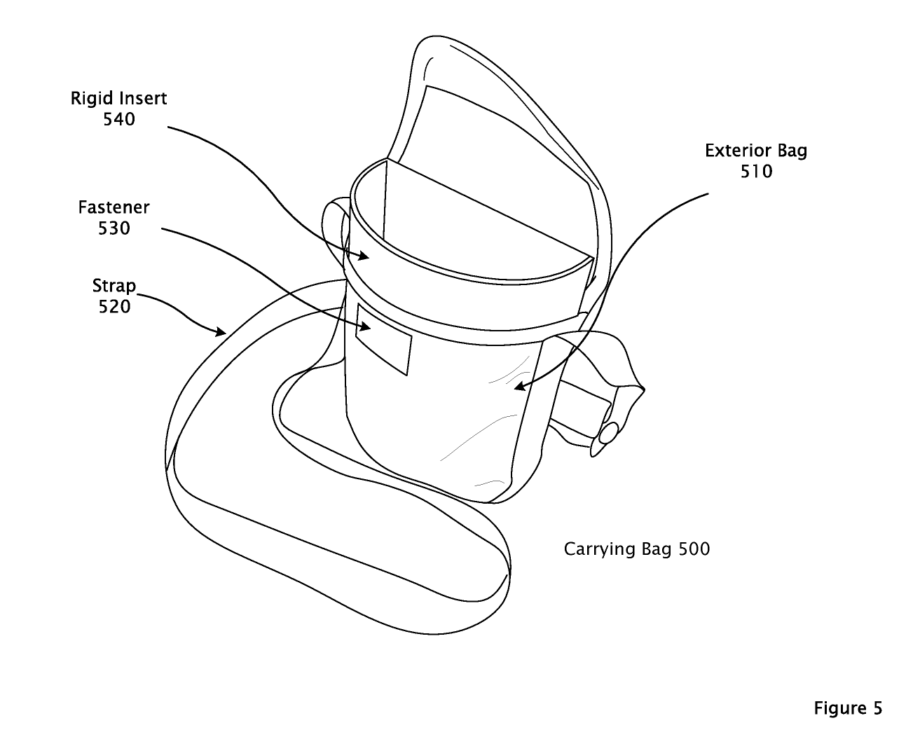

FIG. 5 illustrates Carrying Bag 500 according to yet another embodiment. Carrying Bag 500 may comprise an Exterior Bag 510, which may be made of various fabrics, such as nylon or neoprene, for example, and may be machine washable. Exterior Bag 510 may be configured to receive a Rigid Insert 540, which may prevent items that are stored inside Carrying Bag 500 from getting damaged. Rigid Insert 540 may protect contents from damage or loss caused by spillage or changes in pressure, moisture, or heat, for example. Rigid Insert 540 may be made of plastic, rubber, or other material, and may be easily removable for cleaning.

Carrying Bag 500 may include Adjustable Strap 520, which may be configured to allow a user to carry the Carrying Bag in a cross-body, over-the-shoulder, or around-the-waist manner, for example. Carrying Bag 500 may be light-weight, waterproof, water-resistant, or stain-resistant, and may be made in various colors, shapes, and sizes.

Fastener 530 may hold Exterior Bag 510 closed when fastened. Fastener 530 may use magnets, a friction coupling, hook and loop fasteners, snaps, or any other fasteners to hold securely when closed but open easily, which may allow a user to open Exterior Bag 510 with a single hand.

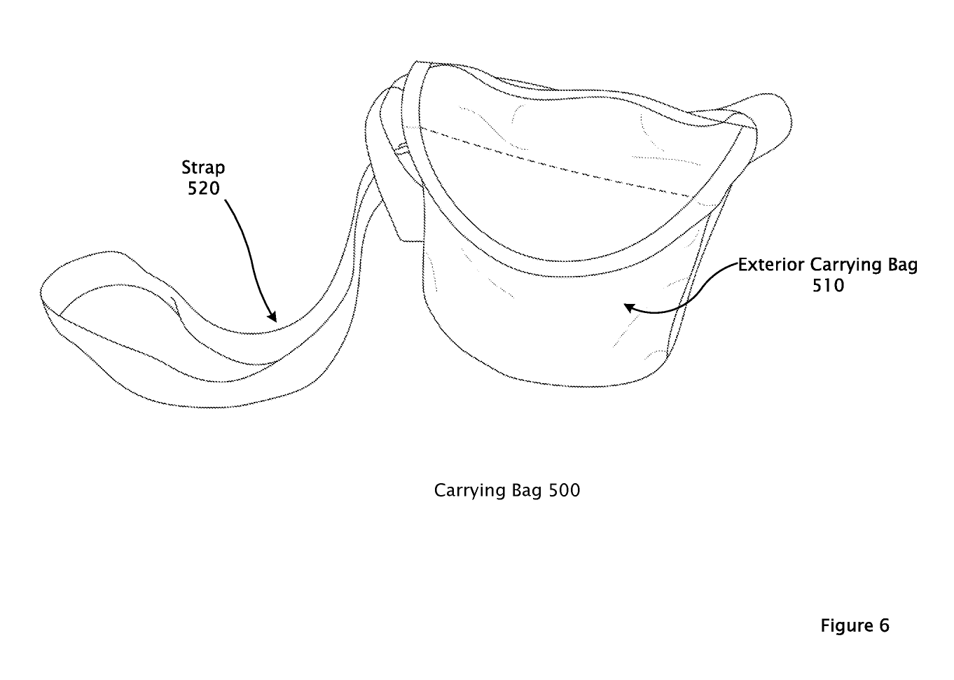

FIG. 6 illustrates Carrying Bag 500 in a closed configuration. In one embodiment, Carrying Bag 500 may include a deodorize or scent-emitting device to prevent or mitigate release of unwanted smells from the bag. In another embodiment, Carrying Bag 500 may include an insulating material, for example, to keep contents cool or preserved.

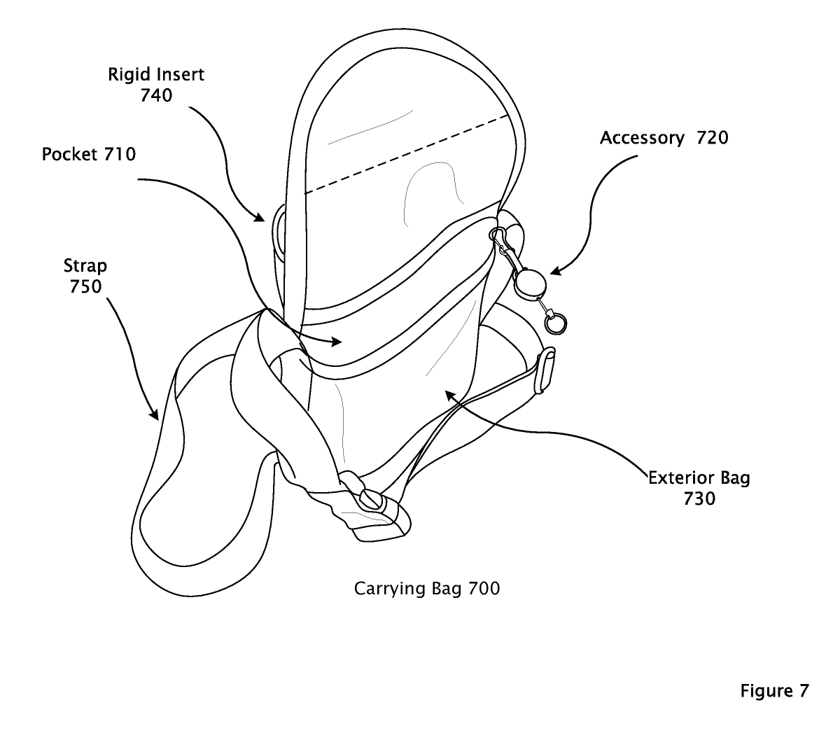

FIG. 7 illustrates Carrying Bag 700 according to yet another embodiment. In Carrying Bag 700 may include interior or exterior Pockets 710 for storing, for example, empty plastic or biodegradable waste bags, keys, cards, or other items.

Carrying Bag 700 may comprise an Exterior Bag 730, which may be made of various fabrics, such as nylon or neoprene, for example, and may be machine washable. Exterior Bag 730 may be configured to receive a Rigid Insert 740, which may prevent items that are stored inside Carrying Bag 700 from getting damaged. Rigid Insert 740 may protect contents from damage or loss caused by spillage or changes in pressure, moisture, or heat, for example. Rigid Insert 740 may be made of plastic, rubber, or other material, and may be easily removable for cleaning.

Carrying Bag 700 may include Adjustable Strap 750, which may be configured to allow a user to carry Carrying Bag 700 in a cross-body, over-the-shoulder, or around-the-waist manner, for example. Carrying Bag 700 may be light-weight, waterproof, water-resistant, or stain-resistant, and may be made in various colors, shapes, and sizes.

Carry Bag 700 may also include Accessory 720 removably coupled or fastened permanently. Accessory 720 may be, for example, a key leash.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

1. A bag, comprising:
an exterior casing,
an interior casing, the interior casing operable to fit inside the exterior casing, wherein the interior casing is removable from the exterior casing,
a handle, and
a pocket.

2. The interior casing of claim 1, wherein the interior casing is operable to maintain a shape.

3. The interior casing of claim 2, further comprising a rigid material.

4. The handle of claim 1, wherein the handle comprises items from a list containing a strap, wristlet, anklet, belt, and hook.

5. The handle of claim 1, wherein the handle has an adjustable length.

6. The bag of claim 1, further comprising a water-resistant material.

7. The bag of claim 1, further comprising a stain-resistant material.

8. The bag of claim 1, further comprising an electronic power source.

9. The bag of claim 1, further comprising a port operable to receive electronics.

10. The bag of claim 1, further comprising an object from the list containing lights, reflectors, and light-emitting diodes (LEDs).

11. The bag of claim 1, further comprising a fastener operable to keep the bag or its components closed.

12. The bag of claim 1, further comprising wheels.

13. The bag of claim 1, further comprising an insulating material.

14. The bag of claim 1, further comprising a deodorizer.

15. The bag of claim 1, further comprising a scent-emitting device.
